(19) United States
(12) Patent Application Publication
(10) Pub. No.: US 2012/0073504 A1
(43) Pub. Date: Mar. 29, 2012

(54) Decorative Pillow for Home with a Cat

(76) Inventor: Wendy Diamond, New York, NY (US)

(21) Appl. No.: 13/244,447

(22) Filed: Sep. 24, 2011

Related U.S. Application Data
(60) Provisional application No. 61/386,101, filed on Sep. 24, 2010.

(51) Int. Cl. A01K 29/00; A01K 15/02

(52) U.S. Cl. 119/28.5

(57) ABSTRACT

A decorative pillow for a couch, bed or piece of furniture made of two or more pieces of fabric, preferably containing stuffing and catnip to entice a cat. In the preferred embodiment, the outside of the pillow is formed of tough, upholstery material. In this embodiment, the inside of the pillow is provided with resilient foam and catnip infused or located within the foam. In this embodiment, the foam insert is coated with a layer of sand paper-like material for filing a cat's claws scraping or being drawn over it as the cat's claws penetrate the tough outer layer of material. In an alternate embodiment, the pillow is provided, on its outside, with one or more pieces of cat claw-smoothing or filing material such that the cat, when playing and trying to rip or claw at the pillow will actually be smoothing and filing its claw(s).

### CROSS REFERENCE TO RELATED APPLICATIONS

This application claims priority from U.S. Provisional Patent Application Ser. No. 61/386,101, entitled “Decorative Pillow for Home with a Cat”, filed on 24 Sep. 2010. The benefit under 35 USC §119(e) of the United States provisional application is hereby claimed, and the aforementioned application is hereby incorporated herein by reference.

### FEDERALLY SPONSORED RESEARCH

Not Applicable

### SEQUENCE LISTING OR PROGRAM

Not Applicable

### TECHNICAL FIELD OF THE INVENTION

The present invention relates generally to household pet products. More specifically, the present invention relates to the care of cats within a home environment.

### BACKGROUND OF THE INVENTION

It is well known that household cats have claws and that it is considered somewhat inhumane (leaving a cat defenseless if allowed outdoors in potential contact with other animals) and likely painful, in any event, to have those claws removed. However, household cats have an apparent instinct to use their claws and to thus tear and shred fabric, furniture, couches, etc. within the home. Thus, allowing a cat to retain its claws, use its instinctive behavior and, yet, somehow minimize the damage which a cat with claws can inflict on the furniture of the home, are highly desired yet somewhat conflicting goals. The present invention is directed to a decorative pillow for open viewing as an item of decoration and, yet, inconspicuous placement in a living area, as on a couch, bed, chair, etc. and, yet, the pillow is cat-friendly in that it is provided with catnip or a similar cat-friendly or attracting component to encourage the cat to play with and use the pillow as it is also provided with a mechanism for entertaining the cat, distracting it from other furniture items, and for smoothing or filing the claws of the cat.

In one embodiment of the invention the pillow is formed of tough outside fabric similar to upholstery fabric. The seams are corded with similar fabric. This encourages the cat to play with it and a home owner will not fret if the cat plays with and tries to destroy it as it is sturdy and easily replaceable, in contrast to curtains, the fabric of the couch, etc. The cat will try to poke its claws through the tough fabric of the pillow. Located interiorly within the tough fabric exterior is a foam insert. This gives the pillow shape and the foam is resilient to allow the cat to play with the pillow—as the cat pushes its feet and claws against the pillow, the pillow resists the pushing and returns to its original shape. In addition, the exterior surface of the foam insert (located within the interior of the pillow as defined by the interior surface of the tough fabric) is provided with a layer of adhesively-secured sand particles or a coating of sand paper-like material. Thus, as the cat's claws actually over time shred and penetrate through the thick and tough outer coating of the pillow, the claws will scrape along and over the grit provided by the sand (whether glued to the foam insert or provided by a separate sheet of sand paper). Yet, the location of the sand allows for a decorative and non-outside surface of claw filing material, and allows the pillow to remain quite decorative. Also, any cat claw filings will be contained within the pillow and not fall onto the couch, i.e., cat claw filings, a consequence of the cat's claws scraping over the surface of the sand, will be trapped between the foam insert's outer layer and the inside of the tough fabric outer layer of the pillow.

In this embodiment, the foam insert and/or its exterior surface provided with sand paper, for filing the cat's claws, are selectively replaceable, as desired.

The interior-located foam insert can be infused with a catnip or cat-attracting substance which can also be replaceable as the item is consumed and the pillow loses its attractiveness. A physical catnip article can be placed into the foam insert or the foam insert can be sprayed with appropriate cat-attracting qualities.

In an alternate embodiment, one or more sections or exterior sides of the pillow are provided with a surface which when the cat instinctively claws the same (attracted to it by the catnip) will file or smooth the claws of the cat.

The pillow thus serves as an attractive article of home decoration, like a decorative throw-pillow for placement on a piece of furniture; yet is a disguised and useful cat care product. It is a cat-friendly toy which will allow the cat to maintain its claws while allowing the cat to instinctively claw at fabric; yet preventing destruction to the furniture of the home and, in addition, the cat's claws are being smoothed or filed by the action of the cat's claws clawing at the smoothing or filing surface of the pillow.

### DESCRIPTION OF THE PRIOR ART

Catnip-containing and cat-friendly toys and other products laced or provided with catnip or catnip-like smells have been used for years. These toys encourage playfulness by the cat with the toy as cats seem to love the smell and thus love to play with the toy containing the smell. Cats will play for hours with a toy which is provided with catnip or a catnip-like smell. The use of toys by cats is considered beneficial to the cat and to the owner of the cat as a toy is an appropriate object for the release of energy by the cat and the cat is generally not bored when playing. This diverts the cat's energy and attention from instinctive yet often destructive behavior, for example, ripping and shredding couches, pillows, curtains, rugs, etc. Pet toys have been made in a wide variety of shapes and out of many different materials, all to divert the cat's attention from destructive behavior and to entertain the cat.

There is a product now on the market, primarily, it seems, sold via a mass-media infomercial (a television ad which extends for more than a mere 30 seconds of broadcast time) which relates to a small ramp which sits on the floor and contains catnip or a catnip scent. The ramp is provided with a series of spaced holes, in the shape of a grate, and the edges of the grating are angled and sharp enough to smooth and file the claws of a cat as the cat pulls its claws across and over the ramp during play. So, the cat is encouraged and drawn to the ramp by the internal catnip and the cat will play and scrape its claws on the fabric of the ramp, for quite some time, all to the beneficial result of occupying the cat and its time, allowing the cat to fulfill its instinct and yet preventing damage to furniture and fabric since the cat will play with the toy, not the furniture and, in any event, the cat's claws are rendered smoother and the ends become filed-down. Thus, the cat is diverted from ripping and shredding other articles of fabric, e.g., curtains, couches, pillows, rugs and carpet, etc. and yet the cat is entertained and it has also performed its instinctive clawing activity. In addition, as it plays with the ramp, the cat's claws are shaved, smoothed or filed down so that the cat, should it decide to claw the fabric or other furniture of the home, will not destroy as much as if the claws were sharp. These ramps, however, are unsightly and one would not normally consider locating the same in one's elegant living room. They do not aesthetically integrate into the decor of stylish living areas. They can be tripped over by visitors and they are just not eye-pleasing. They may entice a cat, as a consequence of the contained catnip, but they are located directly on the floors of the living room and cats often want to scratch and claw on the furniture itself, i.e., the couch, bed, or at least on a surface closer to where the “master”/owner is normally located. This is generally on the furniture and not on the floor. Also, the cat's claw's filings are meant to be captured by the ramp device but not all of the filings are contained. This is unsightly and perceived as unsanitary to the human environment.

Decorative pillows exist for providing accent, color coordination and visual interest to a living area. It is often considered stylish for a couch, chair, or bed to be provided with fabric-covered pillows. Those pillows, however, can become scratch or tear “targets” for a house cat. They can be easily destroyed by a cat who is merely following its instinct in clawing/scratching a fabric article which is located above the floor. Yet, decorative articles are highly desirable and expensive to replace if destroyed by the cat.

It is an object of the present invention to provide a device which attracts a cat and encourages the cat to play with it. It is an object of the present invention to provide a device for a cat which will, upon being played with, smooth or file a cat's claws. It is a further object of the invention to do that in a decorative manner, by use of something which adds to the ambience and look of the living space and does not detract from it. It is an object of the invention and a desired goal to provide a household cat-related device which can sit on a sofa, couch, seat, bed, etc. and not look like a toy for a cat but which, rather, looks like an attractive component of furniture or interior design.

It is an object of the invention to provide a cat-related toy which allows a cat to use its clawing instincts without destroying the fabrics and pieces of furniture. It is also an object of the invention to provide a cat claw filing device which contains and captures the filings of the cat's claw. It is also an object of the present invention to provide a device where the catnip or cat-attracting component is replaceable, as exhausted. It is also an object of the present invention to provide a device which has some internal resiliency so that the cat, when playing, senses a “fight back” to the pillow. This is believed to be more entertaining to the cat. It is also an object of the present invention to provide a cat claw filing surface which can be replaced, when exhausted, without the need to necessarily replace the outside surface of the device.

These and other objects are accomplished by the present invention. The present invention is a decorative and attractive pillow-like device preferably stuffed with foam and formed of one or more layers of sewn-together and tough, upholstery fabric, made into a throw pillow-like device, which contains catnip for attracting a cat, and, further, where one or more surface areas of the interiorly-located foam or the exterior surfaces of the pillow are provided with a sand or coarse fabric which tends to smooth or file the claws of a cat as it pulls its claws over the surface.

### SUMMARY OF THE INVENTION

A decorative pillow, for placement on a piece of furniture, for example, a couch, chair or bed, etc. can be provided with catnip (or another cat-seducing material) and the decorative pillow, independent of shape can be provided on one or more exterior sides or surfaces, in one or more areas, with a cat claw-smoothing or filing surface. Alternatively and preferably, the outside of the pillow is tough fabric and the inside filled with resilient foam. In this embodiment the foam is coated (either adhesively or by mere placement) with sand particles.

In this way, a decorative pillow is provided which can integrate with the decor of a room or room area. Yet the device is truly an inconspicuous cat toy. The pillow is stuffed with the resilient foam to provide it with a nice, i.e., visually pleasing three-dimensional shape. As such it easily and visually integrates into the living space's decor and decorative scheme. The foam insert is infused with catnip or a catnip-like material to encourage the cat to play with the pillow. The pillow thus can be placed within an otherwise elegant living area as it is attractive so as not to negatively impact on the decor and, yet, the cat can play with the pillow, as desired. The playing with the pillow by the cat should be a release for its instinctive scratching and clawing. It will also tend to provide a source of entertainment for the feline.

The pillow is also provided with one or more areas on one or more exterior sides with a cat claw-smoothing or filing component. Alternatively, the foam insert is provided with the sand-coated surface, just inside the tough, outer, fabric layer of material. Preferably, the smoothing or filing material (whether located outside of the pillow or interiorly) will result in smoothing or filing of the cat's claws as the cat plays with the pillow, a consequence of the shape of the pillow, the catnip contained therein, or just because the cat instinctively claws and scratches at the fabric of the pillow. This results in the pillow being scratched or clawed, not the fine furniture, curtains, or other furniture or fabric to the delight of the owner. This also results in the cat's claws becoming smoothed or filed down so that if the cat should claw or scratch other fabric, furniture or materials, less destruction will occur. If the pillow is provided with sand particles within the tough exterior layer of fabric then, as the cat pushes its claws through the tough fabric, the cat's claws will scrape along the sand and smooth the claw, with the filings becoming captured within the boundary defined by the inside of the tough, outside fabric layer. The foam insert can be replaced; the catnip scent can be replaced; the sand coating can be replaced; and, indeed, even the exterior tough fabric can be replaced if destructive shredding occurs.

### BRIEF DESCRIPTION OF THE DRAWINGS

The accompanying drawings, which are incorporated herein an form a part of the specification, illustrate the present invention and, together with the description, further serve to explain the principles of the invention and to enable a person skilled in the pertinent art to make and use the invention.

FIG. 1 is a perspective view of a Decorative Pillow made according to one of the preferred embodiments of the present invention;

FIG. 2 is a side cross-sectional view of a Decorative Pillow made according to the first preferred embodiment of the present invention;

FIG. 3 is a side cross-sectional view of the Decorative Pillow made according to another preferred embodiment of the present invention;

FIG. 4 is a perspective view of a Decorative Pillow made according to one of the preferred embodiments of the present invention; and

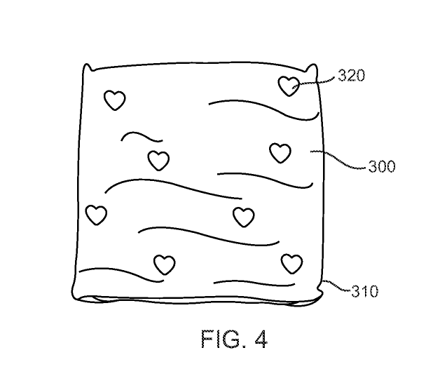

FIG. 5 is a side cross-sectional view of the separate interior compartment for cat nip according to another preferred embodiment of the present invention.

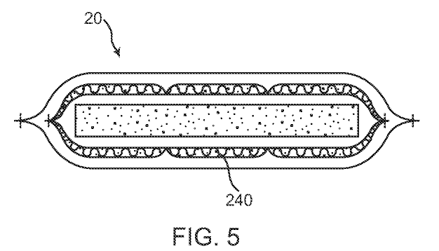

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

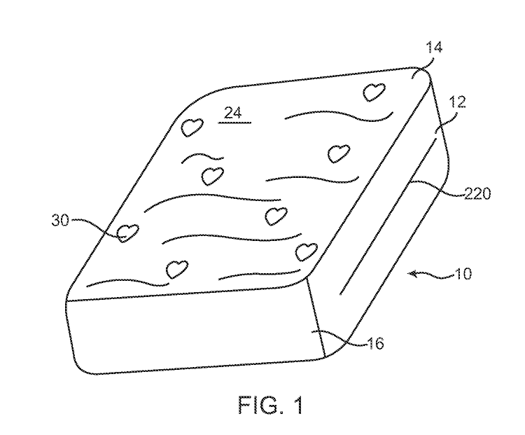

The invention is best understood in connection with a review of the detailed description of the same when considered along with the Drawings, as all understood by those of ordinary skill in the art. As best seen in FIG. 1, a pillow 10, in the shown illustration, like a throw pillow, is formed from one, two, three or more decorative pieces of woven fabric 12 and 14, by a joining seam 16, extending around the perimeter of the joined pieces of fabric 12 and 14. The illustrated design shows spaced hearts 30 but, of course, any design (or no design, so long as the pillow is visually attractive) can be employed without departing from the invention.

In the preferred embodiment the dimensions of the finished pillow are in the range of about 1 to 1½ feet by 1 to 3 feet, by about 3 inches to 1 foot in thickness. The dimensions are dependent upon the style sought and the other pieces of furniture with which the pillow 10 is intended to be placed upon for use. The joining seam 16 can be a simple sewn seam made of interlocked threads and/or can be color-coordinated or contrasting threads. The seam 16 can be provided to join the pieces of fabric and then covered or decorated by a perimeter rope glued thereon or another piece of material of suitable dimension to cover the seam, held thereon by adhesive or glue.

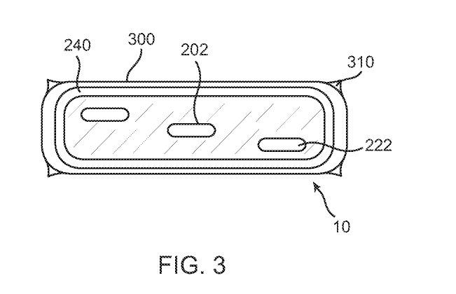

In the preferred embodiment of the present invention shown in FIG. 3, the outer fabric layer 300 is tough, like strong upholstery fabric and covered by a rope-like or welting perimeter 310. The illustrated design shows spaced hearts 302 but, of course, any design (or no design, so long as the pillow is visually attractive) can be employed without departing from the invention.

Preferably, the two pieces of fabric are color coordinated to one another but, of course, they need not be and can be dissimilar, even clashing. However, the piece(s) are sewn together and form a single pillow. The shape of the overall pillow is irrelevant and can be a square, rectangle, have circular end pieces, an odd-shape, the shape of an article (e.g., a whale, octopus, porpoise, etc.). The pillow can be formed from two or more pieces of fabric or even from a single piece of fabric which is suitably cut, then folded on itself about a single or more fold lines, stuffed with material (preferably hypo-allergenic foam) and then sewn to form a closed interior. The pillow 10 is preferably stuffed with some material 20, preferably hypo-allergenic stuffing, foam, cloth, etc. which provides the pillow with three-dimensionality and some softness and also some measure of inherent resiliency from the foam, so that the pillow can actually be used as a cushion for a head, back, neck, etc. Preferably, the cushioning can be the same material as used in current decorative and stuffed pillows and provides the pillow with softness and resilient three-dimensionality.

Preferably, however, the fabric for the exterior of the pillow is attractive to the eye and will be made of highly stylized fabric so that the completed pillow is a decorative pillow intended and suitable for use in a high fashion living room, home, den, etc., on a couch, chair, bed, sofa, etc. Stated differently, if the pillow did not function as a toy for a cat and a cat-claw smoothing and filing device, the pillow would still be a suitable decorative throw pillow for a couch, seat, bed, etc. It is a characteristic of the present invention that the pillow be decorative, meaning pleasing to the eye and capable of coordinating with one or more furniture styles and fabrics used in living areas. It is intended that the present invention aesthetically merge into and otherwise become part of the decor of the room so as not to be evident that it is actually a cat toy/device.

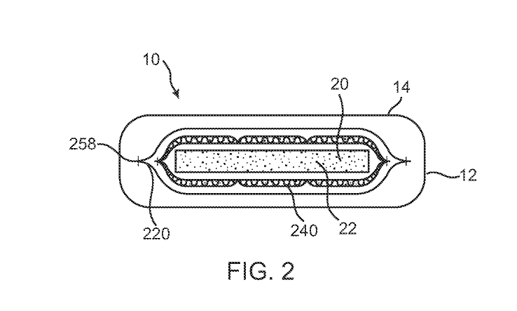

Preferably, the pillow contains a catnip or catnip-like material 22 is located on or in the stuffing/foam 20 and between the pieces of fabric 12 and 14 in one embodiment as show in FIG. 2. This material 22 is meant to attract a cat and the consistency, size, intensity, smell, composition, etc. can be varied as desired, depending upon size of pillow, size of cat, thickness and smell capture/ease of penetration of the catnip from within to the outside fabric, thickness of stuffing 20, etc. The catnip or catnip-like material 22 is meant to attract the interest of the cat to the pillow as a plaything, a toy, something the cat can show interest in without being harmful to the furniture.

In one embodiment, located on at least one exterior side of the pillow 10, a portion thereof or all of one side of the fabric 12 and 14, or extending over a complete side or onto all sides, is a piece of specialty fabric 24 which has the ability to smooth or file a cat's claw(s) as the same is gently stroked over the fabric. Thus, the cat, with its claws, as it seeks to play or claw at the pillow 10, will have its claw(s) come into contact with the specialty piece of material and this, over some short period of time, will smooth or file the sharpness of the cat's claw(s). This will reduce the likelihood of the cat clawing other fabric pieces of furniture. It will result in smoother cat's claws and it will still allow the cat to act out its playfulness and clawing/scratching instincts. However, the decorative pillow, when not being clawed and used by the cat, cat sit or rest on the furniture and a visitor to the living area, unless told of the functionality of the decorative pillow and its use as a cat claw smoother or file, will likely consider that the pillow as decorative. The ordinary and casual observer will likely believe that the decorative pillow 10 is nothing more than a throw pillow that it is intended to visually mesh with and integrate into the decor, styling and color of the other fabric, furniture and colors of the living space.

According to another aspect of the invention, one or more portions of a side of the pillow or an entire exterior side is provided with either normal decorative fabric or cat scratch resistant material so that the cat is encouraged to use the side or portion of the pillow which is provided with the cat claw smoothing and filing side.

According to another preferred embodiment of the present invention illustrated in FIG. 3, the interior of the pillow is provided with a foam insert 202 to provide the pillow with shape and resiliency. The foam insert 202 is replaceable, through a zipper closure 220. Preferably, the foam insert 202 is infused with catnip which can be selectively added to the foam, as the same is exhausted, over time. Also, the foam insert 202 can be shaped with a pocket to hold a catnip-containing device and the device can be replaced, when spent by removing the spend device from the pocket and installing a new device into the pocket.

In the preferred embodiment, the exterior, tough fabric, is formed into the pillow and the seams covered with thick cording or welting. The cord can cover a zipper closure to allow selective access to the interior of the pillow.

In a preferred embodiment of the invention, the foam insert is provided, on its exterior surface (but within the confines defined by the tough exterior material of the pillow) with a sand surface 240. Sand particles can be adhered to the foam insert by glue or suitable adhesive. Alternatively, a layer of sand paper-like material 240 may be attached or placed atop one or more surfaces of the foam insert. This provides the surface(s) of the foam insert with grit so that a cat's claw, when it penetrates the outer, tough material 14 of the pillow 10, will slide across the surface of the layer of sand paper-like material 240 and, in this manner, the cat's claw will become smoothed, like and by the action of an emory board being drawn against a nail. However, here, the cat's claw is being drawn, by the cat's claw shredding though the tough, outer material 14 of the pillow 10, across the sand-coated layer 240 of the foam 20, within the pillow. The sand paper-like surface 240, too, can be selectively replaced, as desired and when spent. Preferably, the device is roughly 3 inches in thickness with a corded seam for a finished look.

It is also an aspect of the present invention that any cat claw filings be captured within the pillow, in the small area defined between the sand surface of the foam and the inside surface of the exterior, tough material of the pillow.

According to another embodiment of the invention, the pillow can be provided at one end with a zipper closure 220 for allowing the stuffing, foam, sand paper-like insert, and cat claw filings to be selectively removed and replaced (not the filings, of course) and for allowing the outside of the pillow to be selectively washed or cleaned. Also, the zipper closure 220 (or other suitable closure mechanism) and its opening 258 will allow the user to selectively replace the catnip 202, as desired. The fabric outer portion of the pillow 300, provided with the component which will smooth and file the cat's claw(s) or the layer 240 sitting atop the interior foam 20 can also be selectively replaceable, by, for example, replacing the entire set of pieces of fabric or a portion thereof. The cat claw-smoothing and filing portion of the decorative pillow can be replaced, as desired, when it becomes ineffective to smooth or file the cat's claw(s), when it becomes visually unappealing, or when the owner merely desires for a change. Also, the cat claw smoothing and filing portion of the fabric can be adjustable in its “strength” or ability to smooth or file by, for example, changing the coarseness of sand paper-like material, its size, spacing of elements, granularity of the material, etc. In the manner that different sizes, grits, “strengths” of sand paper can be used for different woods, finishes, and smoothness desired, the component of the pillow which smoothes and files the cat's claw(s) (whether integrated into the outside surface of the pillow or between the foam and the inside surface of the tough fabric of the pillow 240) can be modified depending upon what end result of smoothness and filing of the cat's claw is desired. The pillow can be provided with a separate compartment 202 defined by a separate closure mechanism 42 for the catnip 222.

When assembled, the present invention provides a decorative pillow for a home. The pillow is visually pleasing and can be placed on a piece of furniture in one's home. The pillow is provided with internal catnip or cat-attracting composite material to encourage a cat to play with the same. In one embodiment, the pillow is also provided with an exterior surface section which when a cat's claw is moved over it, repeatedly, will result in the cat's claw becoming smoother or filed down in sharpness. In the other preferred embodiment, the foam and resilient material within the tough outer layer of material is coated or otherwise provided with a layer of sand paper or sand particles to file the nails/claws of the cat as the cat's claws penetrate the outside layer of material and are pulled or drawn against the sand particles. The cat's claws will tend to shred the outside layer and when they do penetrate into the foam inside material, they will be drawn across the sand, thereby filing the same.

A household cat is expected to be attracted to the pillow and to play with the same. It will thus scratch and rip at the pillow but the home owner will not mind as the cat will not be destroying a piece of furniture but, rather, will actually be smoothing or filing its nails. In any event, the pillow will visually and functionally integrate into the decor of the room so that the room is not provided with an otherwise offensive separate device which clearly is for the cat. That can offend the sensibilities of those who are not cat lovers.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A pillow comprising:
a single piece of fabric which is suitably cut, then folded on itself about one or more fold lines;
a seam joining the fabric together around the perimeter of the folded pieces of fabric;
stuffing material placed within the interior of the joined fabric which provides the pillow with three-dimensionality;
a catnip or catnip-like material located on or in the stuffing material and between the piece of fabric; and
a closing seam sewn to form a closed interior.

2. The pillow of claim 1, wherein
two or more pieces of fabric are seam joined together; and
wherein the two or more pieces of fabric are sewn together and form a single pillow to create the exterior and formed interior of the pillow.

3. The pillow of claim 1, wherein the joining seam is a simple sewn seam made of interlocked threads and/or can be color-coordinated or contrasting threads.

4. The pillow of claim 3, wherein the seam is provided to join the pieces of fabric and then covered or decorated by a perimeter rope glued thereon or another piece of material of suitable dimension to cover the seam, held thereon by adhesive or glue.

5. The pillow of claim 1, wherein the outer fabric layer is an upholstery fabric and covered by a rope-like or welting perimeter.

6. The pillow of claim 1, wherein the stuffing material is hypo-allergenic foam, foam, or cloth.

7. The pillow of claim 1, further comprising
a piece of specialty fabric located on at least one exterior side of the pillow which has the ability to smooth or file a cat's claw(s) as the same is gently stroked over the fabric.

8. The pillow of claim 1, further comprising
a piece of specialty fabric, a portion thereof or all of one side of the fabric extending over a complete side or onto all sides located on at least one exterior side of the pillow, which has the ability to smooth or file a cat's claw(s) as the same is gently stroked over the fabric.

9. The pillow of claim 7, wherein
one or more portions of a side of the pillow or an entire exterior side is provided with either normal decorative fabric or cat scratch resistant material so that a cat is encouraged to use the side or portion of the pillow which is provided with the cat claw smoothing and filing side.

10. The pillow of claim 1, further comprising
the interior of the pillow is provided with a foam insert to provide the pillow with shape and resiliency; and
the foam insert is infused with catnip which can be selectively added to the foam, as the same is exhausted, over time.

11. The pillow of claim 10 wherein
the foam insert can be shaped with a pocket to hold a catnip-containing device; and
the catnip-containing device can be replaced, when spent, by removing the spend device from the pocket and installing a new device into the pocket.

12. The pillow of claim 1, wherein
the exterior fabric, is formed into the pillow and the seams covered with thick cording or welting; and
the cord can cover a zipper closure to allow selective access to the interior of the pillow.

13. The pillow of claim 11, wherein
the foam insert is provided, on its exterior surface, but within the confines defined by the exterior material of the pillow, with a sand surface; and
sand particles are adhered to the foam insert by glue or suitable adhesive.

14. The pillow of claim 11, wherein a layer of sand paper-like material is attached or placed atop one or more surfaces of the foam insert.

15. The pillow of claim 13, further comprising
the exterior of the pillow is provided with a zipper closure;
the interior of the pillow is provided with a foam insert to provide the pillow with shape and resiliency;
the foam insert is replaceable, through the zipper closure; and
the foam insert is infused with catnip which can be selectively added to the foam, as the same is exhausted, over time.

16. The pillow of claim 13, wherein the pillow is provided at one end with a zipper closure for allowing the stuffing, foam, sand paper-like insert, and cat claw filings to be selectively removed and replaced and for allowing the outside of the pillow to be selectively washed or cleaned.

17. The pillow of claim 13, wherein the zipper closure and its opening will allow the user to selectively replace the catnip as desired.

18. The pillow of claim 13, further comprising a separate compartment defined by a separate closure mechanism for the catnip.
